(19) United States
(12) Patent Application Publication
(10) Pub. No.: US 2002/0188627 A1
(43) Pub. Date: Dec. 12, 2002

(54) Interface for real-time feedback of policy views in P3P policy editor

(75) Inventors: Terry Michael Bleizeffer, Durham, NC (US); Mark David Gilmore, Durham, NC (US); Martin Joseph Clayton Presler-Marshall, Chapel Hill, NC (US)

Correspondence Address: A. Bruce Clay, IBM Corporation T81/503, PO Box 12195, Research Triangle Park, NC, 27709, US

(73) Assignee: International Business Machines Corporation, Armonk, NY (US)

(21) Appl. No.: 09/877,536

(22) Filed: Jun. 8, 2001

(51) Int. Cl. G06F 17/24

(52) U.S. Cl. 707/500; 707/501.1; 707/513

(57) ABSTRACT

A graphical user interface tool is provided to help users design privacy policies. The interface allows the user to group, manipulate, and describe the data used by a Web site. A data elements portion of the interface allows the user to view predefined data elements and to create additional data elements. The properties of the data elements may be viewed and modified. The data elements are displayed according to the hierarchical schema defined by the P3P specification. A groups portion of the interface allows the user to create groups of data elements that share common properties, such as how the recipient will use the data. A group may be populated with instances of data elements from the data elements portion of the interface. A policy portion of the interface displays descriptions of the policy in several forms. Statements in the policy are formed from the groups in the groups portion of the interface. The policy may be generated dynamically each time a group is created or a data element is added to a group or modified. A P3P policy may also contain global information, such as the name and address of the organization posting the policy. This information is presented and edited through a policy properties dialog.

### BACKGROUND OF THE INVENTION

1. Technical Field

The present invention relates to data processing and, in particular, to privacy policies in network data processing systems. Still more particularly, the present invention provides an interface for real-time feedback of policy views in a privacy policy editor.

2. Description of Related Art

The Platform for Privacy Preferences (P3P) is a protocol that enables Web sites to express their privacy practices in a standard format that can be retrieved automatically and interpreted easily by user agents. P3P user agents allow users to be informed of site practices (in both machine- and human-readable formats) and to automate decision-making based on these practices when appropriate. Thus, P3P enables a browser to transparently transmit sensitive data, such as a credit card number, to a P3P-enabled Web site and users need not read the privacy policies at every site they visit.

The P3P specification defines the syntax and semantics of P3P privacy policies and the mechanisms for associating policies with Web resources. P3P policies consist of statements made using the P3P vocabulary for expressing privacy practices. P3P policies also reference elements of the P3P base data schema—a standard set of data elements. The P3P specification includes a mechanism for defining new data elements and data sets and a simple mechanism that allows for extensions to the P3P vocabulary.

By following the P3P specification, it is possible to create a privacy policy without using an automated tool; however, the process is very difficult. Previous implementations addressing this problem have used an “interview” approach to gathering data. The user is led through a set of questions resulting in a completed policy. However, this approach forces the user to answer questions without knowing how the answers will affect the final outcome. Furthermore, the interview approach either places constraints upon the user to avoid errors or provides little or no feedback when errors do occur. Therefore, it would be advantageous to provide an interface for real-time feedback of policy views in a P3P policy editor.

### SUMMARY OF THE INVENTION

The present invention provides a graphical user interface tool to help users design privacy policies. The interface allows the user to group, manipulate, and describe the data used by a Web site. A data elements portion of the interface allows the user to view predefined data elements and to create additional data elements. The properties of the data elements may be viewed and modified. The data elements are displayed according to the hierarchical schema defined by the P3P specification. A groups portion of the interface allows the user to create groups of data elements that share common properties, such as how the recipient will use the data. A group may be populated with instances of data elements from the data elements portion of the interface. A policy portion of the interface displays descriptions of the policy in several forms. Statements in the policy are formed from the groups in the groups portion of the interface. The policy may be generated dynamically each time a group is created or a data element is added to a group or modified. A P3P policy may also contain global information, such as the name and address of the organization posting the policy. This information is presented and edited through a policy properties dialog.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating a screen of display of a main policy editor window in accordance with a preferred embodiment of the present invention;

FIGS. 5A and 5B are diagrams illustrating screens of display of a properties dialog in accordance with a preferred embodiment of the present invention;

FIG. 6 is a flowchart illustrating the operation of an editor initialization process in accordance with a preferred embodiment of the present invention;

FIG. 7 is a flowchart illustrating the operation of the policy editor in accordance with a preferred embodiment of the present invention; and

FIG. 8 is a flowchart illustrating the operation of generating the privacy policy in accordance with a preferred embodiment of the present invention.

### DETAILED DESCRIPTION OF THE PREFERRED EMBODIMENT

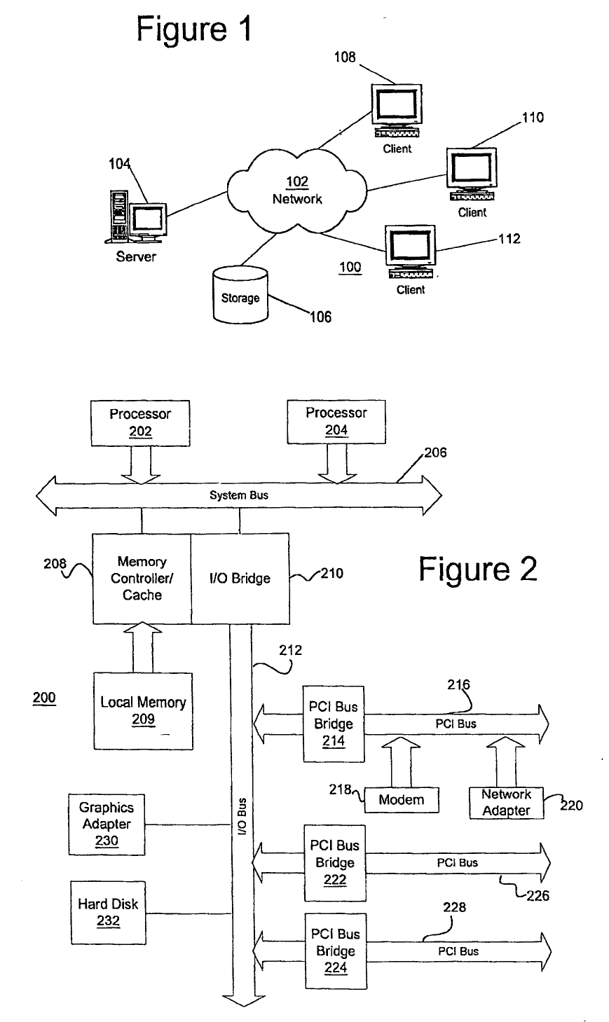

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, New York, running the Advanced Interactive Executive (AIX) operating system or LINUX operating system.

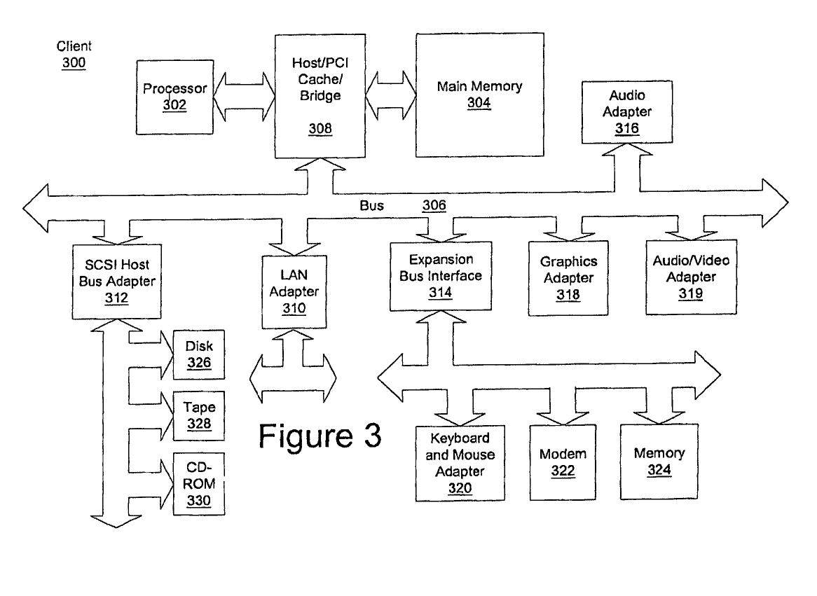

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Returning to FIG. 1, network 102 may be the Internet and server 104 may be a Web server providing World Wide Web content. In accordance with a preferred embodiment of the present invention, a Web site hosted by server 104 has associated therewith a privacy policy compliant with the P3P specification.

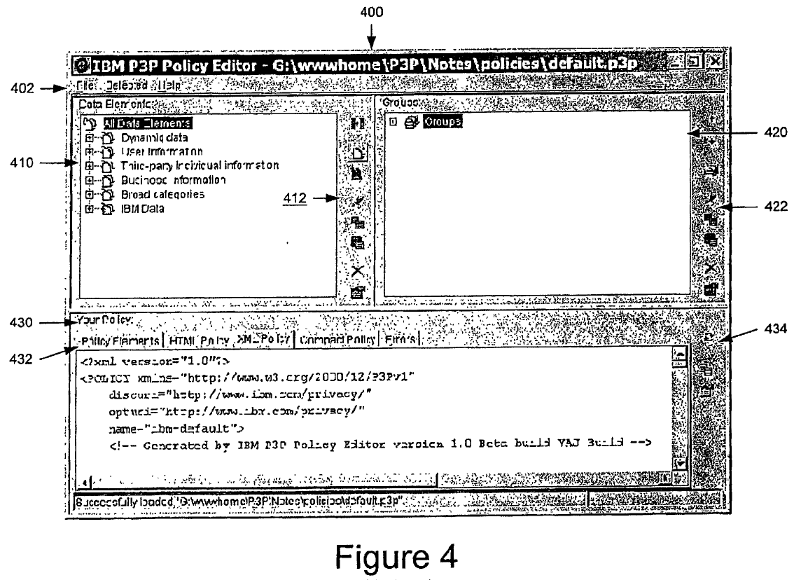

With reference to FIG. 4, a diagram illustrating a screen of display of a main policy editor window is shown in accordance with a preferred embodiment of the present invention. The screen comprises main policy editor window 400, including a title bar, which may display the name of the application program. The title bar also includes a control box, which produces a drop-down menu (not shown) when selected with the mouse, and “minimize”, “maximize” or “restore”, and “close” buttons. The “minimize” and “maximize” or “restore” buttons and determine the manner in which the program window is displayed. In this example, the “close” button produces an “exit” condition when selected. The drop-down menu produced by selecting the control box includes commands corresponding to “minimize,” “maximize” or “restore,” and “close” buttons, as well as “move” and “resize” commands.

Main policy editor window 400 also includes a menu bar 402. Menus to be selected from menu bar 402 may include “File,” “Selected,” and “Help.” However, menu bar 402 may include fewer or more menus, as understood by a person of ordinary skill in the art. Main policy editor window 400 also includes data elements pane 410, groups pane 420, and policy pane 430. Data elements pane 410 includes data elements buttons 412, which include “Move,” “Create Data Set,” “Create Data Element,” “Cut,” “Copy,” “Paste,” “Delete,” and “Properties” buttons displayed from top to bottom. These buttons, as well as menu commands that may be presented through menu bar 402, may be used to manipulate data elements in the data elements pane. Modifications to data elements may result in dynamic regeneration of the policy in policy pane 430.

Groups pane 420 includes group buttons 422, which include “Move Up,” “Move Down,” “New Group,” “Cut,” “Copy,” “Paste,” “Delete,” and “Properties” buttons displayed from top to bottom. These buttons, as well as menu commands that may be presented through menu bar 402, may be used to manipulate data elements in the groups pane. Modifications to data elements or groups may result in dynamic regeneration of the policy in policy pane 430.

Policy pane 430 includes tabs 432 and policy buttons 434. Tabs 432 allow the user to switch between versions of the policy displayed in the policy pane. Tabs 432 include “Policy Elements,” “HTML Policy,” “XML Policy,” “Compact Policy,” and “Errors.” Policy buttons 434 include “Refresh,” “Copy,” and “Policy Properties” buttons displayed from top to bottom. The “Refresh” button allows the user to explicitly refresh the policy. The “Copy” button allows the user to copy the policy to the clipboard. The “Policy Properties” button allows the user to modify policy-wide properties. Modifications to the policy-wide properties may result in dynamic regeneration of the policy in policy pane 430.

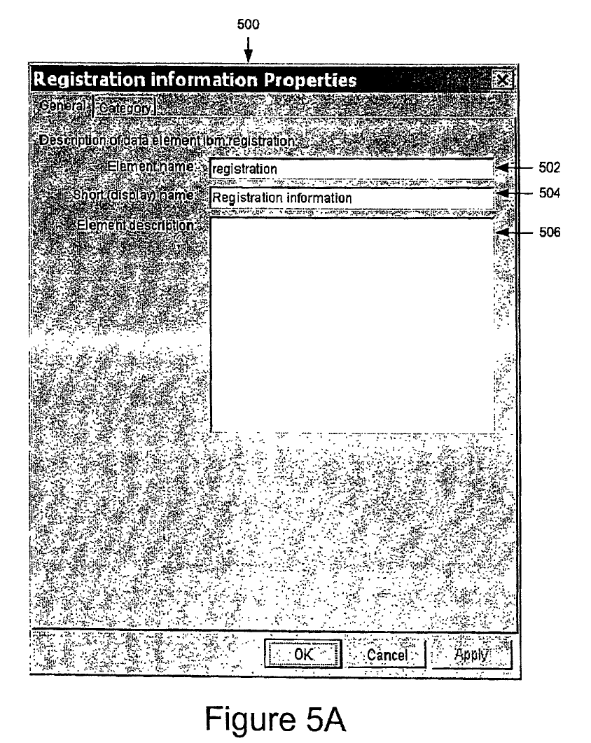

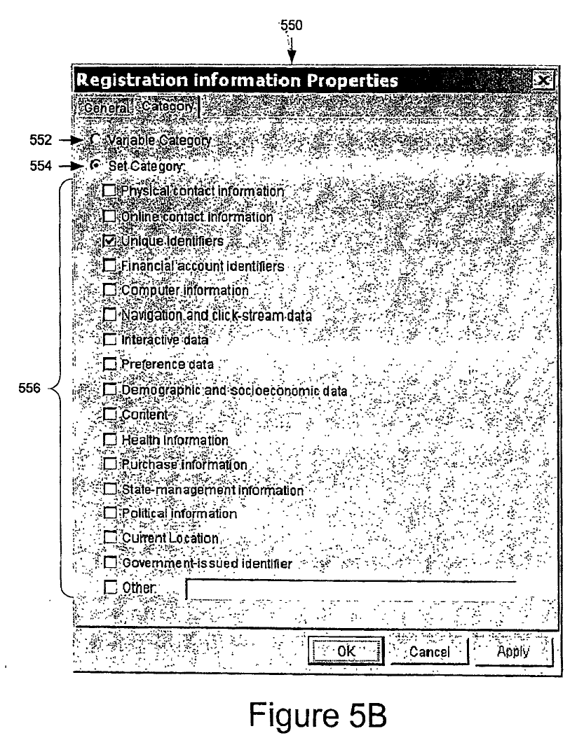

With reference now to FIGS. 5A and 5B, diagrams illustrating screens of display of a properties dialog are shown in accordance with a preferred embodiment of the present invention. Particularly, with respect to FIG. 5A, properties dialog window 500 is a dialog for defining general properties of a data element. Properties dialog window 500 may be used to define an element name 502, short (display) name 504, and an element description 506.

Turning now to FIG. 5B, properties dialog window 550 is a dialog for defining a category for a data element. Properties dialog window 550 may be used to indicate a variable category 552 or a set category 554. If a set category is indicated, one of the set categories 556 may be selected.

1. Orientation.

Previous implementations addressing this problem have used an “interview” approach to gathering data. The user is led through a set of questions, resulting in the completed policy. The present invention takes a different orientation: the most complex task for the user is to describe what data is being collected and how it is used. Thus, the policy editor of the present invention focuses on letting the user group, manipulate, and describe the data the Web site uses. An additional advantage of this approach is that it is far more flexible when the user's task is reviewing or updating a privacy policy, as opposed to creating a new policy from scratch.

The interface shown in FIG. 4 illustrates this. The set of available data elements is shown in the data elements pane. It is initially populated with the predefined data elements defined by the P3P standard, and the user may create additional data elements in the data elements pane. The properties of predefined data elements may be viewed and the properties of new data elements may be defined using the properties dialogs shown in FIGS. 5A and 5B. An example of a property of a data element is the category of the data element. The top right pane shows groups of data. All data elements in a group share certain common properties, such as how the recipient will use that data. A group is populated with instances of data elements from the data elements pane. Individual data element instances also have a few properties, such as whether the site will require this piece of data from the site visitor.

The policy pane is used to display descriptions of the policy in several forms. First, a table of all data elements listed in the policy is given. Second, a hypertext markup language (HTML) version of the policy is shown. Third, the formal extensible markup language (XML) version of the policy is available. A compact policy is also displayed. A compact policy is a summary of what the policy says about the Web site's cookies. Lastly, any errors or warnings that apply to this policy are displayed. When errors are detected in the policy, the error tab may be marked. For example, the word “Error” on the tab may be displayed in a different color, such as red, to alert the user to the detected errors.

2. Hierarchical View of Data Elements.

The P3P specification defines a hierarchical data scheme for use in privacy policies. This schema includes information, such as the site visitor and the site visitor's company. Each of these is the root of a hierarchical data set. For example, “user information” is one data set. Within user information are elements, such as the user's address and birthdate. Each of these elements then contains more specific sub-elements, such as the day, month, and year of the user's birth. P3P policies may also define their own data sets for pieces of information not included in the P3P specification. The policy editor window depicted in FIG. 4 shows how this hierarchy is graphically presented to the user.

3. P3P Statements.

P3P policies contain statements, which list one or more data elements, and make claims, such as how that data will be used and who it will be shared with. The policy editor of the present invention represents each statement as a group, which can be populated by instances of data elements from the data element tree. The claims associated with a statement are presented as properties of that group. A user may click on the properties button or select “properties” from a right-click menu to view and edit those claims.

A single data element is allowed to have instances in multiple groups. The user is presented with several methods for populating groups: the user may drag data elements from the data tree to a group, select a data element and a group and then click “move”, copy data elements from the data tree and paste into a group.

4. Dynamic Display of Policy.

The policy pane allows the user to see the policy in several different formats as it is being created. As the policy is built or edited, policy pane 430 in FIG. 4 shows a list of all the data elements in the policy. A human-readable version (in HTML) and the formal policy (in XML) are also available. This provides the user with an immediate description of the state of the policy. The list of data elements provides a summary of all data elements in the policy to allow the user to easily match up with, for example, a Web form that the policy may cover. The HTML version of the policy explains what the policy says, so that the user can verify that it says what was intended, as the policy is built. Finally, the XML version of the policy is presented for users familiar with the formal P3P language.

5. Dynamic Policy Checking.

The P3P specification defines a number of requirements which a valid privacy policy must meet. For example, the organization posting the privacy policy must give its name, at least one form of contact, and the URL of its human-readable privacy policy. There are also a number of other requirements which a policy should meet. For example, if the Web site covered by the policy has any third-party privacy assurances, then the P3P policy should mention those. The policy editor of the present invention dynamically checks the policy as it is being build or updated to ensure that all of the requirements are met. Policies may be saved even if all of the requirements are not yet met in order to save works in progress. However, the policy editor allows easy access to the list of unmet requirements by including a tab in the policy pane, which lists all errors and warnings that currently apply to the policy. If the policy contains an error, the “Errors” tab is highlighted.

6. Policy-Wide Statements.

A P3P policy contains some global information, such as the name and address of the organization posting the policy. This information is presented and edited through a “policy properties” dialog. One advantage of this approach over an “interview” is that it is easier to update specific parts of the global information. The policy properties dialog uses a set of tabs to allow quick access to any part of the global information. A second advantage to this approach is that the user may enter or update policy properties at any time, rather than forcing users to follow a pre-defined script.

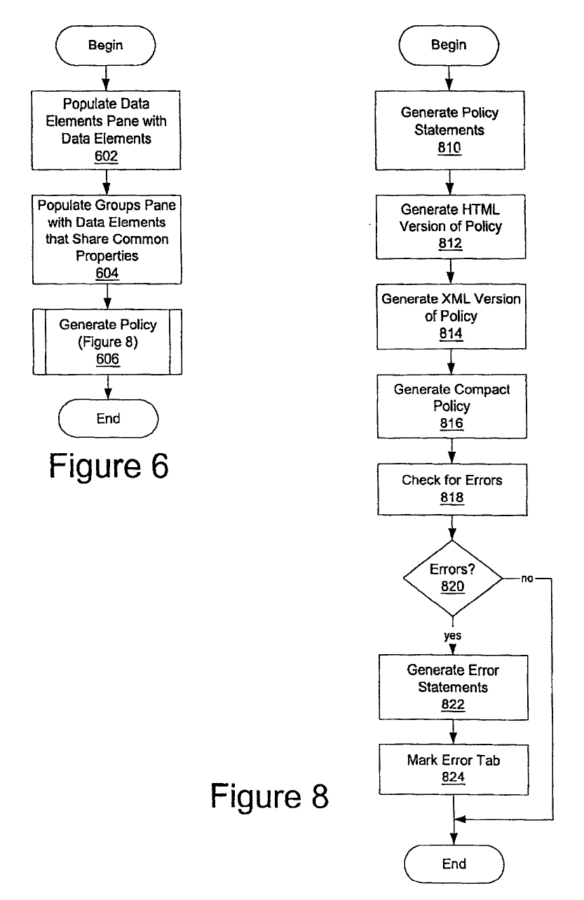

With reference now to FIG. 6, a flowchart illustrating the operation of an editor initialization process is shown in accordance with a preferred embodiment of the present invention. The process begins and populates the data elements pane with predefined data elements (step 602). The predefined data elements include data elements defined by the P3P specification and data elements previously created using the policy editor interface. Next, the process populates the groups pane with data elements that share common properties, as defined using the policy editor interface (step 604). Thereafter, the process generates the policy (step 606). The detailed operation of the process of generating the policy is described below with respect to FIG. 8.

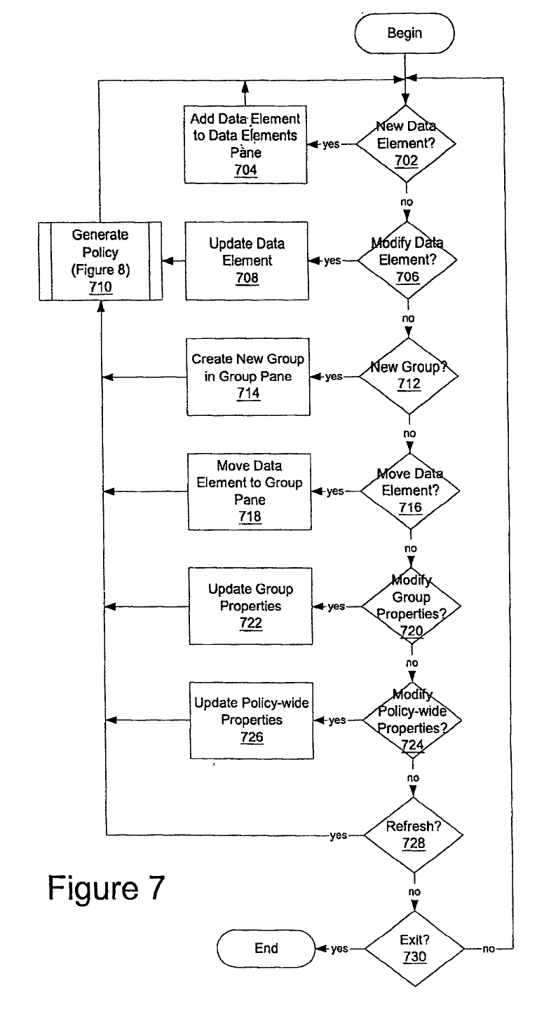

Turning now to FIG. 7, a flowchart is shown illustrating the operation of the policy editor in accordance with a preferred embodiment of the present invention. The process begins and a determination is made as to whether a new data element is being created (step 702). If a new data element is being created, the process adds the data element to the data elements pane of the main policy editor window (step 704) and returns to step 702 to determine if a new data element is being created.

If a new data element is not being created in step 702, a determination is made as to whether a data element is being modified (step 706). If a data element is being modified, the process updates the data element (step 708) and dynamically regenerates the policy (step 710). A data element may be modified by altering properties of the data element using the properties dialog shown in FIGS. 5A and 5B. The detailed operation of the process of generating the policy is described below with respect to FIG. 8. Thereafter, the process returns to step 702 to determine if a new data element is being created.

If a data element is not being modified in step 706, a determination is made as to whether a new group is being created (step 712). If a new group is being created, the process creates the new group in the group pane of the main policy editor window (step 714) and dynamically regenerates the policy (step 710). Next, the process returns to step 702 to determine if a new data element is being created.

If a new group is not being created in step 712, a determination is made as to whether a data element is being moved to the group pane from the data elements pane of the main policy editor window (step 716). If a data element is being moved, the process moves the data element to a group in the group pane (step 718) and dynamically regenerates the policy (step 710). A data element may be moved by clicking and dragging a data element from the data element pane to a group in the group pane. Alternatively, a data element may be moved by copying the data element to the clipboard and pasting the data element to a group in the group pane. Next, the process returns to step 702 to determine if a new data element is being created.

If a data element is not being moved in step 716, a determination is made as to whether group properties are being modified (step 720). If group properties are being modified, the process updates the group properties (step 722) and dynamically regenerates the policy (step 710). Thereafter, the process returns to step 702 to determine if a new data element is being created.

If group properties are not being modified in step 720, a determination is made as to whether policy-wide properties are being modified (step 724). If policy-wide properties are being modified, the process updates the policy-wide properties (step 726) and dynamically regenerates the policy (step 710). Group and policy-wide properties may be modified using a properties dialog similar to the properties dialog for data elements shown in FIGS. 5A and 5B. Thereafter, the process returns to step 702 to determine if a new data element is being created.

If policy-wide properties are not being modified in step 724, a determination is made as to whether a refresh is to be performed (step 728). Some operations performed in the policy editor may not result in the policy being dynamically refreshed. Thus, a user may wish to perform a refresh manually, such as by selecting the refresh button in button bar 434 in FIG. 4. If a refresh is to be performed, the process regenerates the policy (step 710) and returns to step 702 to determine if a new data element is being created.

If a refresh is not to be performed in step 728, a determination is made as to whether an exit condition exists (step 730). An exit condition may exist, for example, when the user closes the main policy editor window. If an exit condition does not exist, the process returns to step 702 to determine if a new data element is being created. If an exit condition exists in step 730, the process ends.

Turning now to FIG. 8, a flowchart illustrating the operation of generating the privacy policy is shown in accordance with a preferred embodiment of the present invention. The process begins and generates policy statements from the groups in the groups pane of the main policy editor window (step 810). Next, the process generates the HTML version of the policy (step 812), generates the XML version of the policy (step 814), and generates the compact policy (step 816).

Thereafter, the process checks for errors (step 818) and a determination is made as to whether errors are found (step 820). If errors are found, the process generates error statements (step 822), marks the error tab (step 824), and ends. If errors are not found in step 820, the process ends.

Thus, the present invention solves the disadvantages of the prior art by providing a P3P policy editor that allows the user to modify individual data elements. The policy editor of the present invention focuses on letting the user group, manipulate, and describe the data that a Web site uses. As opposed to an “interview” approach, a user may review or update a privacy policy, as opposed to creating a new policy from scratch. The properties of predefined data elements may be viewed and modified and the properties of new data elements may be defined using the interface. Groups are populated with instances of data elements and the policy is dynamically generated from the groups. The policy may then be displayed in several forms. The policy editor also checks the policy for errors each time the policy is regenerated.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for creating a privacy policy, comprising:
displaying a plurality of data elements;
generating a privacy policy based on the plurality of data elements;
modifying a first data element from the plurality of data elements; and
dynamically regenerating the privacy policy in response to the modified first data element.

2. The method of claim 1, wherein the step of modifying a first data element comprises modifying a property of the first data element.

3. The method of claim 1, wherein the step of dynamically regenerating the privacy policy comprises generating a human-readable version of the policy.

4. The method of claim 3, wherein the human-readable version of the policy comprises a hypertext markup language version of the policy.

5. The method of claim 1, wherein the step of dynamically regenerating the privacy policy comprises generating an extensible markup language version of the policy.

6. The method of claim 1, wherein the step of dynamically regenerating the privacy policy comprises generating a compact policy.

7. The method of claim 1, wherein the step of dynamically regenerating the privacy policy comprises:
identifying an error in the privacy policy; and
generating an error statement describing the error.

8. The method of claim 1, further comprising:
modifying policy-wide property; and
dynamically regenerating the privacy policy in response to the modified policy-wide property.

9. A method for creating a privacy policy, comprising:
generating a privacy policy based on the plurality of data elements;
modifying policy-wide property; and
dynamically regenerating the privacy policy in response to the modified policy-wide property.

10. The method of claim 9, wherein the step of dynamically regenerating the privacy policy comprises:
identifying an error in the privacy policy; and
generating an error statement describing the error.

11. The method of claim 9, wherein the step of dynamically regenerating the privacy policy comprises generating at least one of a human-readable version of the policy, an extensible markup language version of the policy, and a compact policy.

12. A method for creating a privacy policy, comprising:
displaying at least one policy group, wherein the policy group identifies a plurality of data elements;
generating a privacy policy based on the policy group;
modifying a property of the policy group; and
dynamically regenerating the privacy policy in response to the modified property.

13. The method of claim 12, wherein the step of dynamically regenerating the privacy policy comprises:
identifying an error in the privacy policy; and
generating an error statement describing the error.

14. The method of claim 12, wherein the step of dynamically regenerating the privacy policy comprises generating at least one of a human-readable version of the policy, an extensible markup language version of the policy, and a compact policy.

15. An apparatus for creating a privacy policy, comprising:
display means for displaying a plurality of data elements;
generation means for generating a privacy policy based on the plurality of data elements;
modification means for modifying a first data element from the plurality of data elements; and
regeneration means for dynamically regenerating the privacy policy in response to the modified first data element.

16. The apparatus of claim 15, wherein the modification means comprises means for modifying a property of the first data element.

17. The apparatus of claim 15, wherein the regeneration means comprises generating a human-readable version of the policy.

18. The apparatus of claim 17, wherein the human-readable version of the policy comprises a hypertext markup language version of the policy.

19. The apparatus of claim 15, wherein the regeneration means comprises means for generating an extensible markup language version of the policy.

20. The apparatus of claim 15 wherein the regeneration means comprises means for generating a compact policy.

21. The apparatus of claim 15, wherein the regeneration means comprises:
identifying an error in the privacy policy; and
generating an error statement describing the error.

22. The apparatus of claim 15, further comprising:
means for modifying policy-wide property; and
means for dynamically regenerating the privacy policy in response to the modified policy-wide property.

23. An apparatus for creating a privacy policy, comprising:
generation means for generating a privacy policy based on the plurality of data elements;
modification means for modifying policy-wide property; and
regeneration means for dynamically regenerating the privacy policy in response to the modified policy-wide property.

24. The apparatus of claim 23, wherein the regeneration means comprises:
means for identifying an error in the privacy policy; and
means for generating an error statement describing the error.

25. The apparatus of claim 23, wherein the regeneration means comprises means for generating at least one of a human-readable version of the policy, an extensible markup language version of the policy, and a compact policy.

26. An apparatus for creating a privacy policy, comprising:
display means for displaying at least one policy group, wherein the policy group identifies a plurality of data elements;
generation means for generating a privacy policy based on the policy group;
modification means for modifying a property of the policy group; and
regeneration means for dynamically regenerating the privacy policy in response to the modified property.

27. The apparatus of claim 26, wherein the regeneration means comprises:
means for identifying an error in the privacy policy; and
means for generating an error statement describing the error.

28. The apparatus of claim 26, wherein the regeneration means comprises means for generating at least one of a human-readable version of the policy, an extensible markup language version of the policy, and a compact policy.

29. A computer program product, in a computer readable medium, for creating a privacy policy, comprising:
instructions for displaying a plurality of data elements;
instructions for generating a privacy policy based on the plurality of data elements;
instructions for modifying a first data element from the plurality of data elements; and
instructions for dynamically regenerating the privacy policy in response to the modified first data element.

30. A computer program product, in a computer readable medium, for creating a privacy policy, comprising:
instructions for generating a privacy policy based on the plurality of data elements;
instructions for modifying policy-wide property; and
instructions for dynamically regenerating the privacy policy in response to the modified policy-wide property.

31. A computer program product, in a computer readable medium, for creating a privacy policy, comprising:
instructions for displaying at least one policy group, wherein the policy group identifies a plurality of data elements;
instructions for generating a privacy policy based on the policy group;
instructions for modifying a property of the policy group; and
instructions for dynamically regenerating the privacy policy in response to the modified property.
